(19) United States
(12) Patent Application Publication
(10) Pub. No.: US 2019/0185178 A1
(43) Pub. Date: Jun. 20, 2019

(54) APPARATUS AND METHODS FOR A PORTABLE AVIONICS SYSTEM TO PROVIDE FLIGHT INFORMATION IN A GENERAL AVIATION AIRCRAFT

(71) Applicants: Justin Zhou, Alexandria, VA (US); Maxwell Quinn Lord, McLean, VA (US); Thomas Henri Pajot Baron, McLean, VA (US)

(72) Inventors: Justin Zhou, Alexandria, VA (US); Maxwell Quinn Lord, McLean, VA (US); Thomas Henri Pajot Baron, McLean, VA (US)

(21) Appl. No.: 15/842,078

(22) Filed: Dec. 14, 2017

(51) Int. Cl. B64D 43/02; B64C 13/10; G01C 23/00; G01P 5/165; H04Q 9/00

(52) U.S. Cl. CPC B64D 43/02; B64C 13/10; G01C 23/005; H04W 4/008; H04Q 9/00; H04Q 2209/40; G01P 5/165

(57) ABSTRACT

Apparatus and methods for a portable avionics system to provide flight information in a general aviation aircraft are described herein. The portable avionics system includes a portable sensor pod and a head mounted display system. The portable sensor pod houses sensors and solid state components in a portable container, thereby allowing the pod to be ported to a plurality of general aviation aircraft. The head mounted display system includes a hardware box in wireless communication with the portable sensor pod. Sensor data from the portable sensor pod is transmitted to the head mounted display system and processed so that essential flight information becomes readily available on a wearable display. The wearable display conveys essential flight data to a general aviation pilot without interfering with the pilot's vision.

### BACKGROUND

### Field

The present disclosure relates generally to avionic sensor systems, and more specifically to portable avionics systems using head mounted displays.

### Background

The Federal Aviation Administration (FAA) defines a Loss of Control (LOC) accident as an unintended departure of an aircraft from its controlled flight. According to the FAA, factors contributing to LOC are a pilot's failure to recognize an aerodynamic stall or spin and a pilot's failure to maintain airspeed. Due to a large number of reported general aviation (GA) pilot and passenger fatalities, both the FAA and National Transportation Safety Board (NTSB) have encouraged the general aviation community to seek ways to improve pilot awareness.

Technologies relating to improving pilot awareness and safety include avionics and avionics systems. Avionics pertains to electronic systems used on an aircraft to perform functions relating to aircraft control and to aviation flight procedure. For instance, the avionics in the cockpit of a commercial airline includes electronic communication systems, electronic collision avoidance systems, electronic navigation systems, and the like.

### SUMMARY

Several aspects of a portable avionics system for providing flight information in a general aviation aircraft will be described more fully hereinafter with reference to a portable sensor pod and to a head mounted display system.

In one aspect a portable avionics system for displaying aircraft specific flight information for a plurality of general aviation aircraft types comprises a portable sensor pod and a head mounted display (HMD) system. The portable sensor pod comprises at least one sensor; and the head mounted display system comprises a hardware box and a wearable display. The portable sensor pod is configured to convert sensor data from the at least one sensor into pod output data. The hardware box is configured to receive the pod output data and to convert the pod output data into the aircraft specific flight information; and the wearable display is configured to display the aircraft specific flight information.

The portable sensor pod can be configured to convert the sensor data from the at least one sensor into the pod output data based upon a predetermined formula. The predetermined formula can be calibrated for the plurality of general aviation aircraft types.

The portable sensor pod can further comprise a sensor pod circuit. The sensor pod circuit can comprise a transducer and a wireless transmitter. The transducer can be configured to receive the sensor data from the at last one sensor and to provide a transducer output signal proportional to the sensor data. The wireless transmitter can be configured to transmit the pod output data. The pod output data can comprise a digital representation of the transducer output signal.

The sensor pod circuit can further comprise a microcontroller. The microcontroller can be configured to convert the transducer output signal into the digital representation of the transducer output signal based upon a predetermined formula. The predetermined formula can be calibrated for the plurality of general aviation aircraft types.

The portable sensor pod can further comprise a flange section and an aerodynamically streamlined attachable container section. The flange section can be configured for permanent mounting to the underside of a wing of the aircraft. The attachable container section can comprise a nose cone section and a body section. The attachable container section can be attached to the flange section with a removable pin.

The flange section, the nose cone section, and the body section can be additively manufactured. The flange section can be mounted to the underside of the wing of the general aviation aircraft using an adhesive. The body section and the nose cone section can be sealed together to form the attachable container section.

The hardware box can comprise a wireless receiver and at least one processor. The wireless receiver can be configured to receive the pod output data; and the at least one processor can be configured to convert the pod output data into the aircraft specific flight information. The wearable display can be a wearable display lens.

The at least one sensor can comprise a first pitot tube; and the aircraft specific flight information can comprise airspeed. The at least one sensor can comprise a second pitot tube; and the aircraft specific flight information can comprise angle of attack

In another aspect, a method of displaying flight information for a plurality of general aviation aircraft comprises: attaching a portable sensor pod to a select one of the plurality general aviation aircraft types; measuring sensor data using the portable sensor pod; converting the sensor data to pod output data using the portable sensor pod; wirelessly receiving the pod output data at a head mounted display (HMD) system; converting the pod output data into aircraft specific flight information using a hardware box; and displaying the aircraft specific flight information on a wearable display.

Converting the sensor data to the pod output data using the portable sensor pod can comprise using a microcontroller to convert the sensor data to the pod output data based on a predetermined formula. The predetermined formula can be calibrated for the plurality of general aviation aircraft types.

Attaching the portable sensor pod to the select one of the plurality of general aviation aircraft types can further comprise: permanently mounting a flange section of the portable sensor pod under a wing of the select one of the plurality of general aviation aircraft types; sealing a sensor pod circuit and at least one sensor in an aerodynamically streamlined attachable container section; and attaching the attachable container section to the flange section with a removable pin. The attachable container section can comprise a nose cone section and a body section. The flange section, the nose cone section, and the body section can be additively manufactured.

Permanently mounting the flange section of the portable sensor pod under a wing of the select one of the general aviation aircraft types can comprise mounting the flange section of the portable sensor pod using an adhesive.

Converting the sensor data to the pod output data using the portable sensor pod can comprise: receiving the sensor data from the at last one sensor; providing a transducer output signal proportional to the sensor data; converting the transducer output signal based on a predetermined formula; and wirelessly transmitting the pod output data. The pod output data can comprising a digital representation of the transducer output signal.

Converting the pod output data into aircraft specific flight information using a hardware box can comprise: wirelessly receiving the pod output data; and converting the pod output data into the aircraft specific flight information.

The at least one sensor can comprise a first pitot tube and a second pitot tube; and the aircraft specific flight information can comprise airspeed and angle of attack.

In another aspect, a portable avionics system for displaying aircraft specific flight information for a plurality of general aviation aircraft types comprises: an attaching means, a sensing means, a first converting means, a receiving means, a second converting means, and a displaying means. The attaching means is for attaching a portable sensor pod to a select one of the plurality general aviation aircraft types. The sensing means is for measuring sensor data using the portable sensor pod. The first converting means is for converting the sensor data to pod output data using the portable sensor pod. The receiving means is for wirelessly receiving the pod output data at a head mounted display (HMD) system. The second converting means is for converting the pod output data into aircraft specific flight information; and the displaying means is for displaying the aircraft specific flight information on a wearable display.

In another aspect an avionics system for conveying aircraft specific flight information for a plurality of general aviation aircraft types comprises an avionics sensor hub and an avionics warning system. The avionics sensor hub comprises at least one sensor and is configured to provide hub output data. The avionics warning system comprises a hardware box and a plurality of warning devices. The hardware box is configured to receive the hub output data and to convert the hub output data into the aircraft specific flight information. The plurality of warning devices are configured to convey the aircraft specific flight information.

The avionics sensor hub can be a portable sensor pod configured to convert sensor data from the at least one sensor into the hub output data.

The plurality of warning devices can comprise a wearable display configured to display the aircraft specific flight information. The plurality of warning devices can comprise a light emitting diode (LED) strip configured to display light in response to the aircraft specific flight information. The plurality of warning devices can comprise a stick shaker configured to shake in response to the aircraft specific flight information. The plurality of warning devices can comprise an audible device configured to provide sound in response to the aircraft specific flight information.

The hardware box can comprise a wireless receiver and a processor. The wireless receiver can be configured to receive the hub output data. The processor can be configured to convert the hub output data into the aircraft specific flight information.

It will be understood that other aspects relating to the portable avionics for providing flight information will become readily apparent to those skilled in the art from the following detailed description, wherein it is shown and described only several embodiments by way of illustration. As will be appreciated by those skilled in the art, both electronic hardware and mechanical implementations can be realized with other embodiments without departing from the invention. Accordingly, the drawings and detailed description are to be regarded as illustrative in nature and not as restrictive.

### BRIEF DESCRIPTION OF THE DRAWINGS

Various aspects of apparatus and methods for providing flight information via a portable sensor pod to a head mounted display system will now be presented in the detailed description by way of example, and not by way of limitation, in the accompanying drawings, wherein:

FIG. 1 illustrates a general aviation aircraft using a portable avionics system according to an embodiment.

FIG. 2A illustrates a portable sensor pod attached to a first type of general aviation aircraft according to aspects presented herein.

FIG. 2B illustrates the portable sensor pod attached to a second type of general aviation aircraft according to aspects presented herein.

FIG. 3A illustrates a side view perspective of a separated flange, body, and nose cone for a portable sensor pod according to aspects presented herein.

FIG. 3B illustrates a side view of a flange and an attachable container according to aspects presented herein.

FIG. 3C illustrates a bottom view perspective of a portable sensor pod according to aspects presented herein.

FIG. 3D illustrates a side view perspective of a portable sensor pod including an airspeed pitot tube sensor and angle of attack pitot tube sensor according to aspects presented herein.

FIG. 4A illustrates a side view perspective of a head mounted display (HMD) system according to aspects presented herein.

FIG. 4B illustrates a front view of the head mounted display system according to the example of FIG. 4A.

FIG. 5A illustrates an eyepiece display region of a head mounted display system according to aspects presented herein.

FIG. 5B illustrates flight information displayed in the eyepiece display region of the example of FIG. 5A.

FIG. 6A illustrates a system block diagram of the sensors and sensor pod circuit within a portable sensor pod according to a first example.

FIG. 6B illustrates a system block diagram of the sensors and sensor pod circuit within a portable sensor pod according to a second example.

FIG. 6C illustrates a system block diagram of the sensors and sensor pod circuit within a portable sensor pod according to a third example.

FIG. 7A illustrates a system block diagram of the display and hardware within a head mounted display system according to a first example.

FIG. 7B illustrates a system block diagram of the display and hardware within a head mounted display system according to a second example.

FIG. 8 conceptually illustrates a method of using a portable avionics system according to aspects presented herein.

FIG. 9 conceptually illustrates a flow graph corresponding to measuring air data using a portable sensor pod according to aspects presented herein.

FIG. 10 conceptually illustrates a method of using a head mounted display system according to aspects presented herein.

FIG. 11 illustrates a functional system block diagram of the portable avionics system for measuring air data according to aspects presented herein.

FIG. 12 illustrates a method for calibrating airspeed data for a type of general aviation aircraft according to aspects presented herein.

FIG. 13 illustrates a method for operating avionics hardware of the portable avionics system for measuring air data according to aspects presented herein.

FIG. 14A illustrates a system block diagram of a portable avionics system using a hardware box according to aspects presented herein.

FIG. 14B illustrates a system block diagram of a general avionics system using a hardware box according to aspects presented herein.

### DETAILED DESCRIPTION

The detailed description set forth below in connection with the drawings is intended to provide a description of exemplary embodiments of portable avionics relating to providing flight information using portable sensor pods and head mounted display systems. Further, it is not intended to represent the only embodiments in which the invention may be practiced. The term “exemplary” used throughout this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the invention to those skilled in the art. However, the invention may be practiced without these specific details. In some instances, well-known structures and components may be shown in block diagram form, or omitted entirely, in order to avoid obscuring the various concepts presented throughout this disclosure.

The National Transportation Safety Board (NTSB) has identified prevention of loss of control (LOC) as a top priority of the General Aviation (GA) community. Loss of control incidents account for an unacceptably high percentage of fatalities. According to the NTSB, between the years 2008 to 2014 nearly forty-eight percent of fatal fixed-wing GA accidents in the United States resulted from pilots losing control of their aircraft. The FAA recognizes pilot distraction and loss of situational awareness as one of the largest contributing factors to the high rates of LOC incidents, citing stalls to be the most common end result. Stalls are most common where they are also most deadly: during maneuvers and pattern flight.

While there are many ways to curb the occurrence of LOC incidents with training and briefing, one of the NTSB's suggestions is to install technology that improves the pilot's awareness. Although avionics displays and electronic flight instrument systems (EFIS) have been developed to enhance the interpretation of the data being taken by sensors and to consolidate flight data, affordable avionics to readily display essential flight information have not yet been developed for the general aviation pilot. And while there may be applications of advanced avionics display systems for the military or commercial airline industry, these advanced avionics systems are not readily deployed in a general aviation aircraft. Accordingly, there is a need for an avionics system which readily displays essential flight information to a general aviation pilot. Further, there is a need for an avionics system which can be easily implemented in a general aviation aircraft.

Apparatus and methods for a portable avionics system to provide flight information in a general aviation aircraft are described herein. The portable avionics system includes a portable sensor pod and a head mounted display system. The portable sensor pod houses sensors and solid state components in a portable container, thereby allowing the pod to be ported to a plurality of general aviation aircraft. The head mounted display system includes a hardware box in wireless communication with the portable sensor pod. Sensor data from the portable sensor pod is transmitted to the head mounted display system and processed so that essential flight information becomes readily available on a wearable display. The wearable display conveys essential flight data to a general aviation pilot without interfering with the pilot's vision.

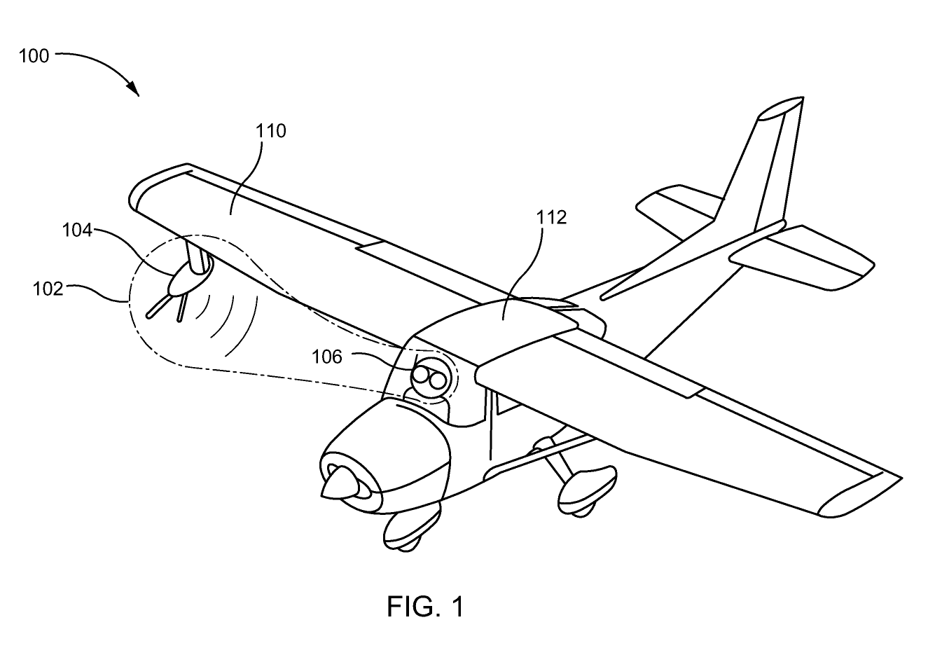

FIG. 1A illustrates a general aviation (GA) aircraft 100 using a portable avionics system 102 according to an embodiment. The GA aircraft 100 can be a civilian aircraft, such as a light sport propeller aircraft, for use by a general aviation pilot. The avionics system 102 includes a portable sensor pod 104 and a head mounted display system 106. Prior to takeoff the portable sensor pod 104 can be removably attached to a secure location, such as a tie down location or a preinstalled attachment point, at the underside of a wing 110; and a general aviation pilot can wear all or part of the head mounted display system 106. The portable sensor pod 104 can probe aerodynamic and/or air data from outside the cockpit 112 and convert the probed sensor data into sensor pod data for transmission to the head mounted display system 106 inside the cockpit 112.

The sensor pod data can be transmitted to the head mounted display system 106 via a radio frequency (RF) carrier. For example, Bluetooth® (a registered trademark of Bluetooth Special Interest Group (SIG) technologies; hereinafter referred to as Bluetooth) and Bluetooth technology can be used to allow the portable sensor pod 104 to wirelessly communicate with the head mounted display system 106. In other examples, WiFi or other wireless communication technologies may be employed. Upon flight completion, the portable sensor pod 104 can be removed for recharging and/or for porting to a different type of general aviation aircraft.

The portable avionics system 102 can advantageously be used to constantly provide flight data, including essential flight data, to a general aviation pilot during flight without distracting the pilot. In some embodiments, the portable avionics system 102 can be used to constantly provide flight data within the general aviation pilot's field of regard and/or field of view on a wearable display and/or lens. For instance, essential flight data including airspeed and/or angle of attack (AOA) can be provided to the general aviation pilot on a wearable display so the pilot will always be aware of these essential flight parameters even while scanning outside of the cockpit 112. As general aviation pilots and those of skill in the art can appreciate, constantly being aware of airspeed and angle of attack flight information can be essential in preventing accidental stalls.

As illustrated on the general aviation aircraft 100 of FIG. 1A, the portable sensor pod 104 can be small and have a small form factor to advantageously mount to a plurality of general aviation aircrafts. Having a small form factor, the portable sensor pod 104 can be mounted so as to have a negligible effect and/or no effect on the aerodynamic properties of the general aviation aircraft 100.

Also, the portable sensor pod 104 can be an independent unit. For instance, it can use a rechargeable battery to serve as a power source, independent of the electrical power source in the general aviation aircraft 100. Being both portable and having wireless capability, the portable sensor pod 104 can be mounted to the wing 110 with either small and/or no modification to the general aviation aircraft 100. However, in other embodiments a power source from the general aviation aircraft 100 may be used to provide power and/or battery charge to the portable sensor pod 104.

In some embodiments the portable sensor pod 104 can be calibrated in advance for a plurality of general aviation aircraft types. As one skilled in the art can appreciate, there are many types, models, and variations of aircraft and general aviation aircraft. In the disclosure herein a general aviation aircraft type can mean the general aircraft type, manufacture, characteristics, and/or model which may affect aerodynamic flight behavior in a way that requires the calibration of avionic sensors. For instance, a Cessna 172, which has one type of wingspan, may be distinguished from a Piper Cherokee which has another type of wingspan. In the disclosure herein, “general aviation aircraft” can also be referred to by the terms “aircraft”, “airplane”, and/or “aviation aircraft.” Additionally, the term “portable sensor pod” can also be referred to by the term “pod”, “sensor pod”, and/or “portable pod.”

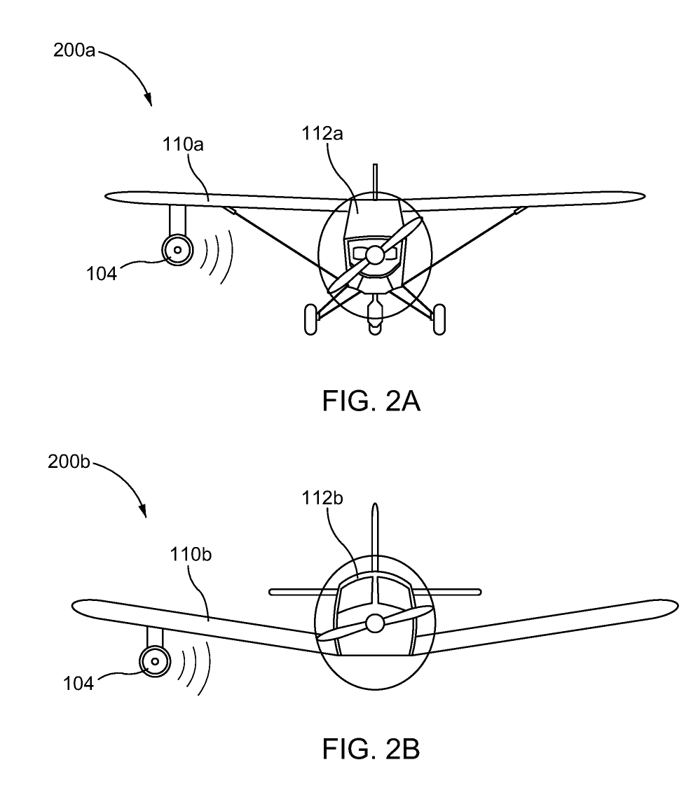

FIG. 2A illustrates a portable sensor pod 104 attached to a first type of general aviation aircraft 200a according to an embodiment. FIG. 2B illustrates the portable sensor pod 104 attached to a second type of general aviation aircraft according to another embodiment. As illustrated in FIG. 2A, the general aviation aircraft 200a has a different wingspan and aerodynamic profile than that of the general aviation aircraft 200b. An avionics system using the portable sensor pod 104 can be calibrated with preset and/or predetermined aircraft dependent calibration data and/or formulas. In this way the sensor pod 104 can be mounted to the wing 110a of general aviation aircraft 200a so that essential calibrated flight data is readily displayed to a general aviation pilot in the cockpit 112a via a head mounted display system.

Similarly, by virtue of the preset aircraft calibration, the portable sensor pod 104 can also be mounted to the wing 110b of general aviation aircraft 200b so that essential calibrated flight data is readily displayed to a general aviation pilot in the cockpit 112b via a head mounted display system.

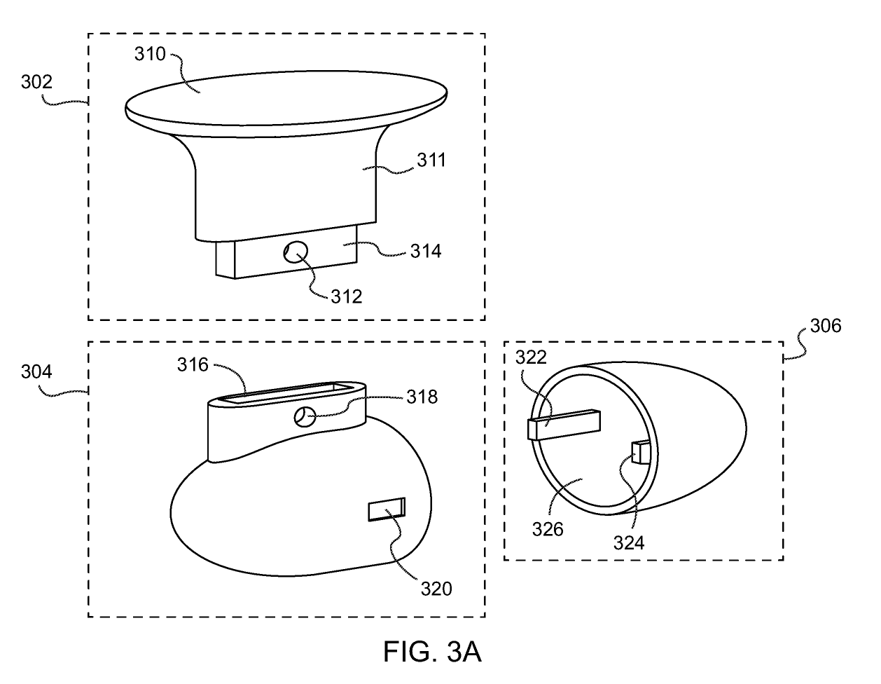

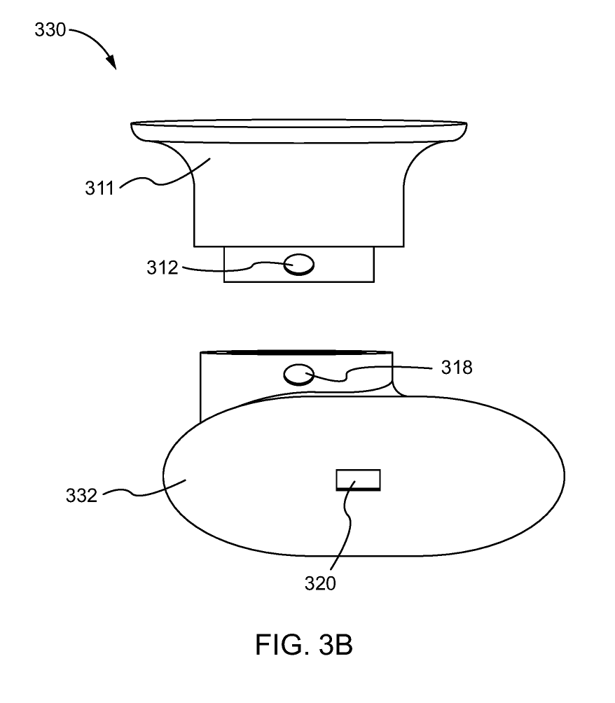

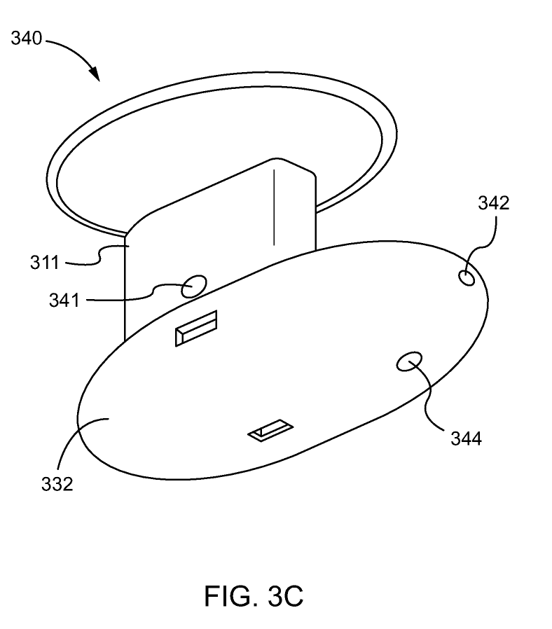

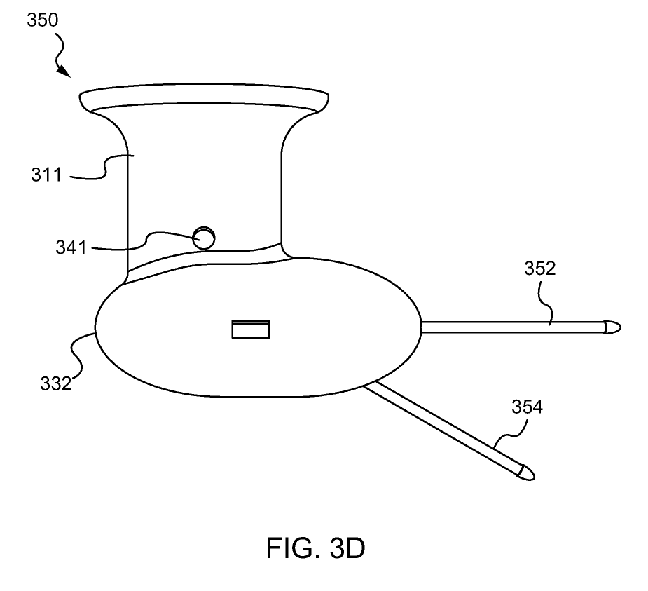

FIG. 3A illustrates a side view perspective of a separated flange 302, body 304, and nose cone 306 for a portable sensor pod according to an embodiment. FIG. 3B illustrates a side view 330 of a flange 302 and an attachable container 332 according to an embodiment; and FIG. 3C illustrates a bottom view perspective 340 of a portable sensor pod according to an embodiment.

The flange 302 has a top surface 310, a support section 311, a flange connector section 314, and a flange attachment hole 312. The body 304 is a hollow section with a notch 316, a body attachment hole 318, and a utility hole 320. The nose cone 306 has an interior surface 326, a first tab 322, and a second tab 324.

The flange 302, body 304, and the nose cone 306 can be manufactured to be aerodynamically streamlined so that there is negligible and/or no aerodynamic load interference. In some embodiments the flange 302, body 304, and the nose cone 306 can be additively manufactured, e.g., using a three dimensional (3D) printer. Avionics including hardware circuits, sensor pod circuits, power supplies, batteries, and sensors, can be installed inside hollow portions of the body 304 and nose cone 306. The first tab 322 and the second tab 324 can then be inserted into the body 304 to secure the body 304 to the nose cone 306 prior to sealing the body 304 and the nose cone 306 together. Body 305 may have a corresponding recess or notch that is configured to receive the first tab 322 and the second tab 324 of the nose cone.

As illustrated in FIG. 3B, the sealed body 304 and the nose cone 306 can form the attachable container 332 which may attach to the flange 302 with a pin or similar attachment device. The top surface 310 of the flange 302 may be attached to a part of an aviation aircraft with an adhesive to advantageously make for an easy portable installation before flight and uninstallation after flight for the user. Additionally, the utility notch 320 can be used to mount a hardware switch to operate as an on/off switch to enable or disable the installed avionics and hardware circuits.

As shown in FIGS. 3A-C, the flange connector section 314 can be inserted into the notch 316 so that the flange attachment hole 312 aligns with the body attachment hole 318 to form an alignment hole 341. In this way a pin or similar attachment device such as a rivet may be inserted to secure the flange 302 to the attachable container 332.

As shown in FIG. 3C, the attachable container 332 can include a pitot hole 342 and a pitot hole 344; and FIG. 3D illustrates a side view perspective 350 of a portable sensor pod including an airspeed pitot tube 352 and angle of attack pitot tube 354 according to an embodiment. As shown in FIG. 3C and FIG. 3D, the airspeed pitot tube 352 can be inserted into the pitot hole 342; and the angle of attack pitot tube 354 can be inserted into the pitot hole 344 at an installment angle with respect to the airspeed pitot tube 352. The installment angle can be any angle of magnitude greater than 0 degrees; for instance, in some embodiments the installment angle may be 30 degrees, and in other embodiments the installment angle may be 45 degrees.

During flight, the airspeed pitot tube 352 can probe air data having a first flow vector angled directly in line with an airplane's geometric heading; and the angle of attack pitot tube 354 can probe air data having a second flow vector rotated by the installment angle with respect to the first vector flow. As will be further disclosed herein, the probed air data from the airspeed pitot tube 352 can advantageously be used to provide airspeed; and the probed air data from both the airspeed pitot tube 352 and angle of attack pitot 354 can be used to provide angle of attack.

Although the embodiment of FIGS. 3A-D describes a portable sensor pod using a flange 302 for mounting the attachable container 332 to an aircraft, other configurations are possible. For instance, in some embodiments an attachable container may be attached to other parts of an aircraft, such as to a tie-down anchor point. Also, within the disclosure herein “attaching a portable sensor pod” can also refer to “attaching the attachable container of the portable sensor pod.”

In addition, although the attachable container 332 is shown to have two pitot holes 342 and 344, other attachable container configurations are possible. For instance, an attachable container may have greater or fewer than two pitot holes to hold greater or fewer pitot tubes (also referred to as static pitot tube systems). In some embodiments the attachable container 332 may have only an airspeed pitot tube 352, and in some embodiments the attachable container 332 may include an additional side slip pitot tube for probing air data having a third flow vector. The third flow vector may be used to provide additional flight information such as aircraft sideslip. In other embodiments additional sensors including proximity sensors and/or global positioning system (GPS) sensors can be sealed within or outside the attachable container 332 to probe additional aspects of flight.

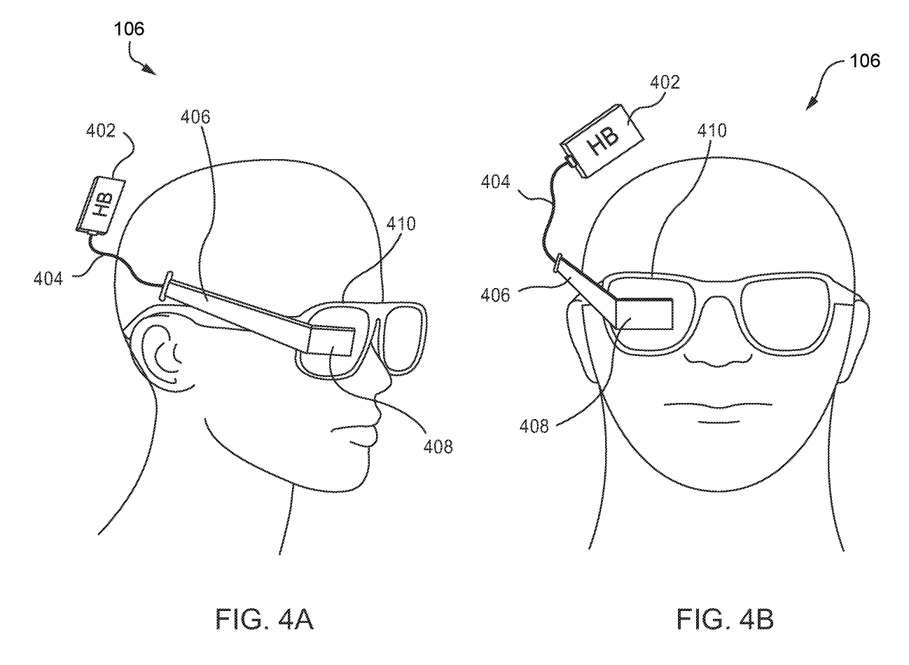

FIG. 4A illustrates a side view perspective of a head mounted display (HMD) system 106 according to an embodiment. The HMD system 106 includes a hardware box 402, a signal cable 404, and a display module 406 with a display 408 for displaying flight information at an eyepiece 410. FIG. 4B illustrates a front view of the head mounted display system 106 according to the embodiment of FIG. 4A. The hardware box 402 can comprise hardware and/or avionics for wirelessly receiving and for processing data from the portable sensor pod. A function of the hardware box 402 can be to convert wirelessly received data into flight information for display via the display module 406 with the display 408. The display 408 can be an organic light emitting diode (OLED); and the hardware box 402 can be a computer, a mobile device, a tablet, or similar system comprising hardware for receiving wireless signals and performing signal processing operations to display flight information at the eyepiece 410.

In some embodiments the hardware box 402 can be conveniently attached to a wearable device, such as a hat, headband, glasses, helmet, etc. In other embodiments, the hardware box 402 may be placed in a small pouch for attachment to a piece of clothing or behind a hat. The signal cable 404 can be a high definition multimedia interface (HDMI) cable for carrying HDMI signals to the display module 406. The eyepiece 410 can include glasses, sunglasses, eyepieces, and the like. In some embodiments the display module 406 can comprise a commercial off the shelf (COTS) component. For instance, the display module 406 can be part of a Vufine® HDMI compatible wearable display which may attach to glasses, headbands, hats, and other head apparel. (Vufine® is a registered trademark of Vufine, Inc. of Sunnyvale, Calif. 94086; hereinafter referred to as Vufine.)

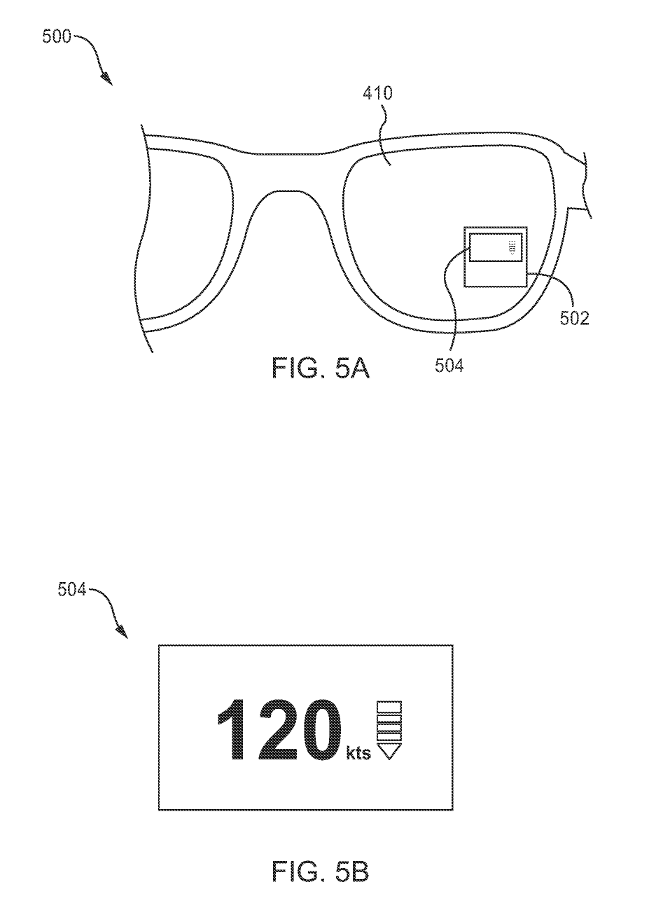

FIG. 5A illustrates an eyepiece display region 502 of a head mounted display system according to an embodiment; and FIG. 5B illustrates flight information 504 displayed in the eyepiece display region 502 of the embodiment of FIG. 5A. The head mounted display system can be the HMD system 106 of FIGS. 4A-B configured to display essential flight data on the eyepiece 410. As shown in the embodiment of FIGS. 5A-B, the flight information 504 conveys airspeed (120 kts) in knots (kts) within the eyepiece display region 502.

As shown in FIG. 5A, the eyepiece display region 502 can be a small region of the eyepiece 410. The eyepiece display region 502 can be positioned at any location on either the left or right eyepiece so that the flight information occupies a small zone in the pilot's field of regard. In this way essential information can be constantly and promptly conveyed to a general aviation pilot even while the pilot is looking outside of the cockpit. In some embodiments angle of attack can also be conveyed within the display region 502. Angle of attack can be conveyed in numeric form and/or in symbolic form. In other embodiments additional flight information including rate of descent and/or climb can also be represented in symbolic form. Symbolic information can be conveyed with colors to immediately distinguish dangerous situations, like unsafe airspeed and/or unsafe angles of attack. In other embodiments angle of attack can be conveyed via a sound warning system, such as a stall warning indicator, within the cockpit.

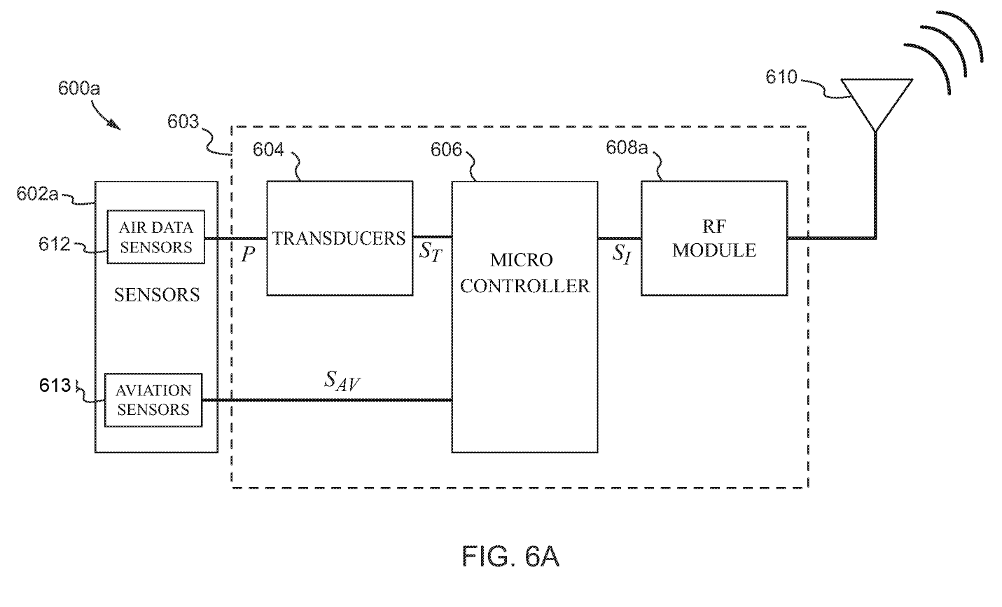

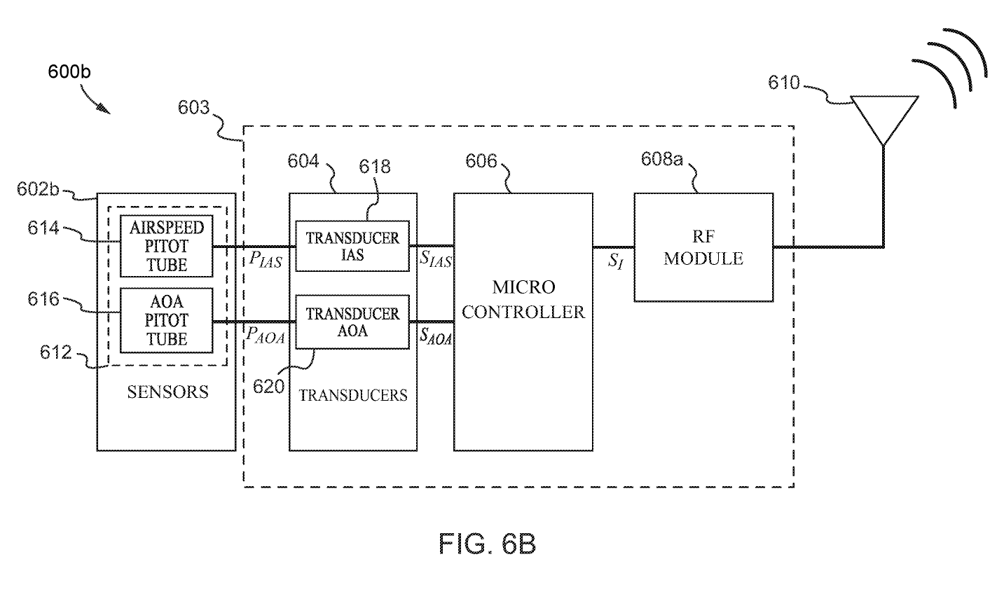

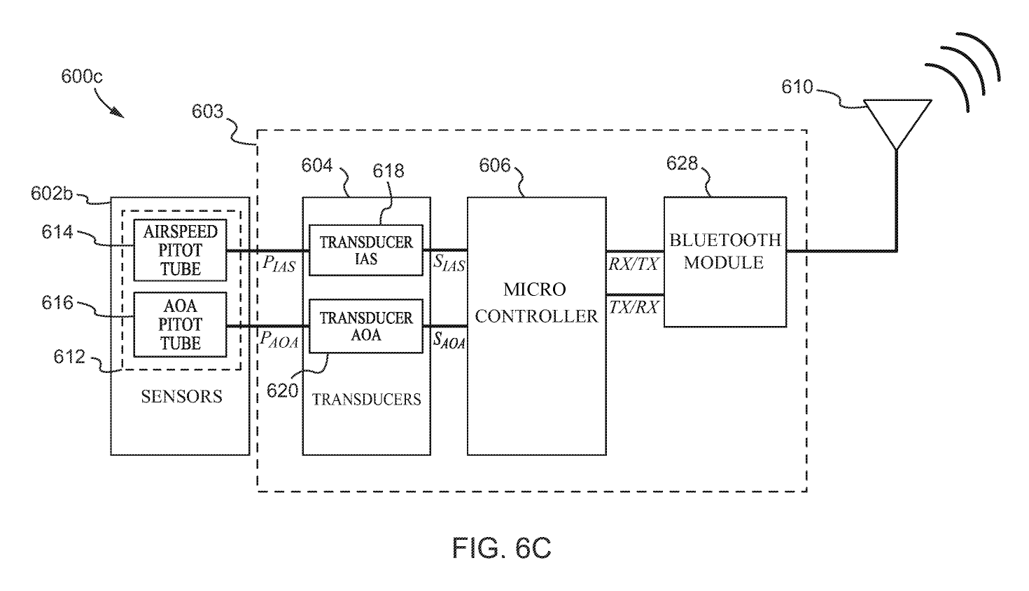

FIG. 6A illustrates a system block diagram 600a of the sensors 602a and sensor pod circuit 603 within a portable sensor pod according to a first embodiment. The system block diagram 600a shows the sensors 602a, the sensor pod circuit 603, and an antenna 610a. The system block diagram can represent the avionics and/or hardware system components which may be sealed inside an attachable container 332 as described in the discussion of FIGS. 3A-D.

The sensors 602a can comprise air data sensors 612 and aviation sensors 613. Examples of air data sensors 612 may include pitot-static systems, which can be also be referred to as “pitot tubes” and/or “differential barometers.” As one of ordinary skill in the art can appreciate, the pitot tubes can be used to probe and measure differential pressure between static and total impact pressure. For instance, the airspeed pitot tube 352 can probe and provide a differential pressure between the total impact pressure along the first flow vector and the static pressure. Examples of aviation sensors 613 may include an altimeter, compass, GPS, and/or attitude determination sensor. For instance, an ultrasonic ground proximity sensor, for assisting a pilot with flare timing, can be installed at the bottom of the attachable container 332.

As illustrated the sensor pod circuit 603 includes transducers 604, a microcontroller 606, and an RF module 608a. The transducers 604 can be used to convert non-electrical signals into analog signals. For instance, the transducers 604 can include a piezoresistive pressure transducer for converting differential pressure P from the air data sensors 612 into a transducer output signal S_{T}. The transducer output signal S_{T} can be an analog signal which is then coupled to an analog input of the microcontroller 606. Also, the aviation sensors 613 can provide sensor output signals S_{AV}, which may be either digital and/or analog signals and which may be coupled to digital and/or analog inputs of the microcontroller 606.

As one of ordinary skill in the art can appreciate, the microcontroller 606 can be configured to process the signals S_{T} and S_{AV} to provide an output signal or vector of output signals S₁ to the RF module 608a. For instance, the microcontroller 606 can be programmed to provide digital data S₁ in a serialized format to the RF module 608a. The microcontroller 606 can also be programmed with instructions including preset data and/or predetermined formulas to account for an aircraft's characteristics. For instance, aircraft specific calibration data for the sensors 602a can be programmed into the memory and/or into predetermined formula instructions within the microcontroller 606. Having preset data and/or predetermined formulas programmed into the microcontroller 606 can advantageously allow a pilot to attach the attachable container 332 to multiple aircraft types without having to perform an initial calibration flight test.

The RF module 608a can transmit pod output data via antenna 610. The pod output data can comprise digital information including the digital data S₁. In some embodiments the antenna 610 can be fully integrated into the RF module 608a.

FIG. 6B illustrates a system block diagram 600b of the sensors 602b and sensor pod circuit 603 within a portable sensor pod according to a second embodiment. The system block diagram 600b is similar to the system block diagram 600a, except it uses sensors 602b. The system block diagram 600b can represent avionics within the portable sensor pod enclosure of FIG. 3D configured for probing airspeed and angle of attack. Sensors 602b include the air data sensors 612 which comprises an airspeed pitot tube 614 and an angle of attack (AOA) pitot tube 616.

The airspeed pitot tube 614 and the angle of attack pitot tube 616 can be system block diagrams of the airspeed pitot tube 352 and the angle of attack pitot tube 354 of FIG. 3D. The airspeed pitot tube 614 provides a differential pressure P_{IAS} to a transducer 618, which converts differential pressure P_{IAS} into a proportional analog signal S_{IAS}. Similarly, the angle of attack pitot tube 616 provides a differential pressure P_{AOA} to a transducer 620, which converts differential pressure P_{AOA} into a proportional analog signal S_{AOA}.

The microcontroller 606 can receive the analog signals S_{IAS} and S_{AOA} and convert them into the digital data S₁. The microcontroller 606 can convert both of the analog signals S_{IAS} and S_{AOA} to airspeed data based on a predetermined formula, which can be calibrated for multiple aircraft types.

FIG. 6C illustrates a system block diagram 600c of the sensors 602b and sensor pod circuit 623 within a portable sensor pod according to a third embodiment. The system block diagram 600c is similar to the system block diagram 600b, except it uses sensor pod circuit 623; also, sensor pod circuit 623 is similar to sensor pod circuit 603 except the RF module 608a is replaced with a Bluetooth module 628 having serial data RX/TX input ports. As shown in FIG. 6C, the processor/controller can have serial data output ports TX/RX coupled to the RX/TX input ports of the Bluetooth module 628.

As one of ordinary skill in the art can appreciate, FIGS. 6A-C show system level diagrams which can be realized with circuit components. In addition, a circuit level realization can include additional components, connections, and/or features which are not conveyed at the system level. For instance, a circuit realization of FIG. 6C can include an on/off switch; in addition the circuit realization can include power management modules and components such as step-up converters, low dropout regulators, and/or rechargeable batteries.

Additionally, as one of ordinary skill in the art can appreciate, the microcontroller 606 can be realized with a microcontroller such as the Arduino/Nano. The Arduino/Nano can be preprogrammed with calibration data and/or a predetermined air data (airspeed) formula so that the system represented by FIGS. 6A-6C can be attached to a plurality of aviation aircraft types.

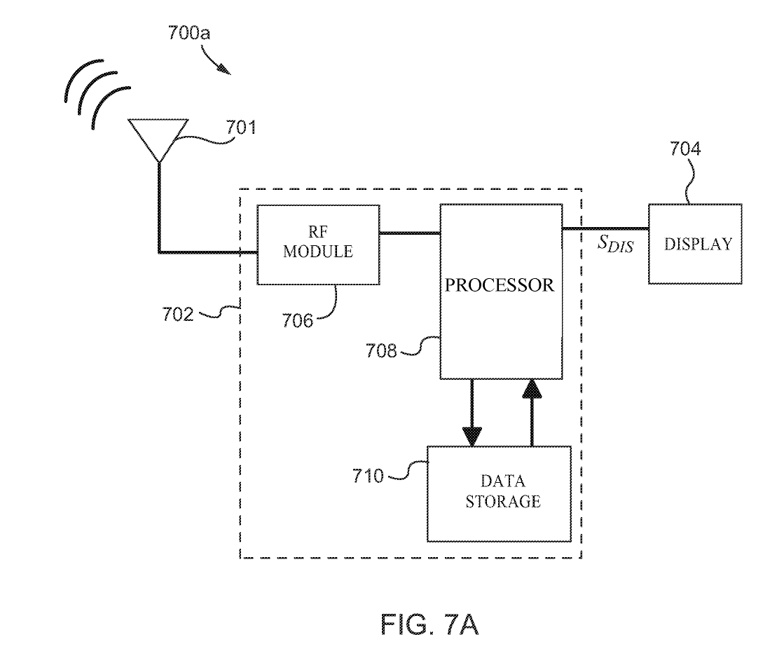

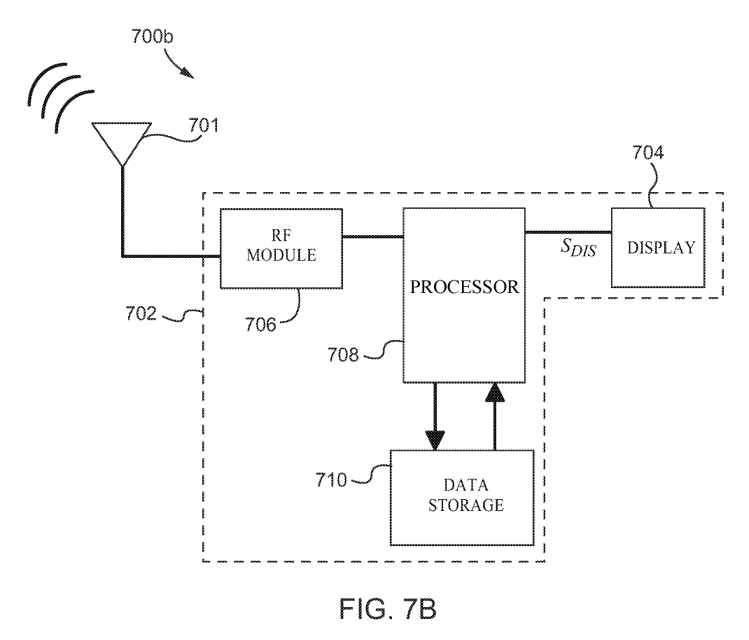

FIG. 7A illustrates a system block diagram 700a of the display 704 and hardware components 702 within a head mounted display system according to a first embodiment. The system block diagram 700a also illustrates an antenna 701 which wirelessly receives the pod output data from a sensor pod circuit as described above in the discussion of FIGS. 6A-C. The system block diagram 700a can also represent the avionics and/or hardware system components corresponding to the head mounted display system 106 described above.

The hardware components 702 include an RF module 706, a processor 708, and data storage 710. The hardware components 702 and antenna 701 can represent some or all of the components within the hardware box 402. For instance, the processor 708, antenna 701, and RF module 706 can be components realized within a laptop, tablet and/or similar computer system, such as Raspberry Pi Zero W. As one skilled in the art can appreciate, a Raspberry Pi Zero performs the functions of a computer including both WiFi and Bluetooth. In addition, the data storage 710 can refer to both internal and external removable data storage such as a secure digital (SD) card and/or a removable hard drive.

The hardware components 702 can perform processing calculations and smoothing algorithms. For instance, program instructions can be stored into the data storage 710 and accessed to perform angle of attack calculations based on the received pod output data. When the pod output data has information from an airspeed pitot tube 352 and an angle of attack pitot tube 354, angle of attack can be calculated by solving a system of two equations and two unknowns to estimate the angle of attack. In addition flight information including flight path and aircraft flight pattern can be stored into the data storage 710 for later retrieval. The stored flight information can advantageously assist a pilot to objectively learn from prior flight patterns.

In addition to performing processing calculations, the hardware components 702 may convert and/or format signals to be compatible with the display 704. For instance, when the display 704 is an HDMI display, the signals S_{DIS} may be provided in HDMI format. FIG. 7B illustrates a system block diagram 700b of the display 704 and hardware components 702 within a head mounted display system according to a second embodiment. The system block diagram 700b can represent an integrated realization of the hardware components 702 and display 704. For instance, the hardware components 702 and display 704 can be fully integrated into the lens and/or surrounding lens frame. Alternatively, the system block diagram 700b can represent an integrated realization wherein the display 704 is integrated with the hardware components 702 inside the hardware box 402.

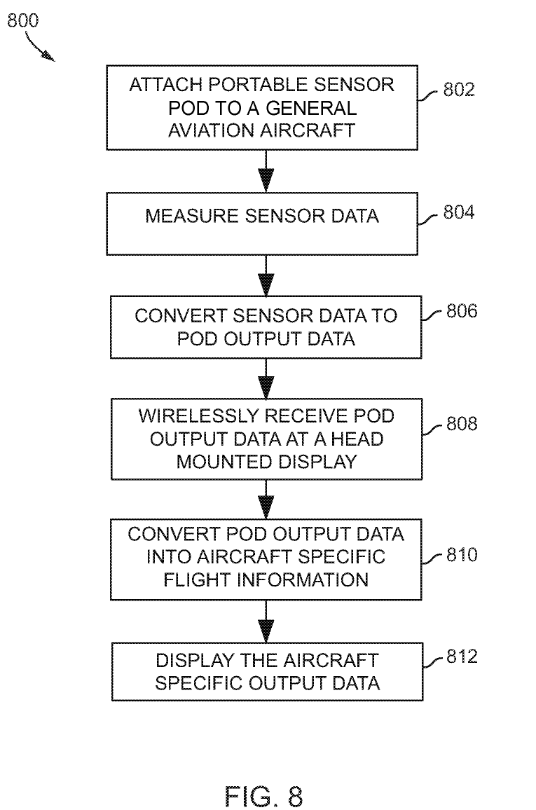

FIG. 8 conceptually illustrates a method 800 of using a portable avionics system (e.g., 102) according to an embodiment. The method 800 comprises six operations 802, 804, 806, 808, 810, and 812 which can be executed in sequence. The first operation 802 can correspond to attaching the portable sensor pod 104 to a general aviation aircraft wing. The portable sensor pod 104 can comprise a sensor pod circuit with a microcontroller 606, and the microcontroller 606 can use a predetermined formula with sensor calibration data corresponding to the general aviation aircraft. The next operation 804 can correspond to measuring sensor data. For instance, air data from the airspeed pitot tube 352 and air data from the angle of attack pitot tube 354 can be measured.

The following operation 806 can correspond to converting the sensor data using the predetermined formula. For instance, the microcontroller 606 of FIG. 6C can convert analog signals S_{IAS} and S_{AOA} into pod output data; and the pod output data can correspond to the digital data S₁ provided to and transmitted via the RF module 608a (or Bluetooth module 608b).

Next, operation 808 can correspond to receiving the pod output data at a hardware box 402 of an HMD system 106. As described above, the pod output data may be received via wireless communication between an HMD system 106 and the portable sensor pod 104. Then operation 810 can correspond to converting the received pod output data into aircraft specific flight information S_{DIS}. And finally, operation 812 can correspond to transmitting and/or displaying the aircraft specific flight information S_{DIS} on a display 704.

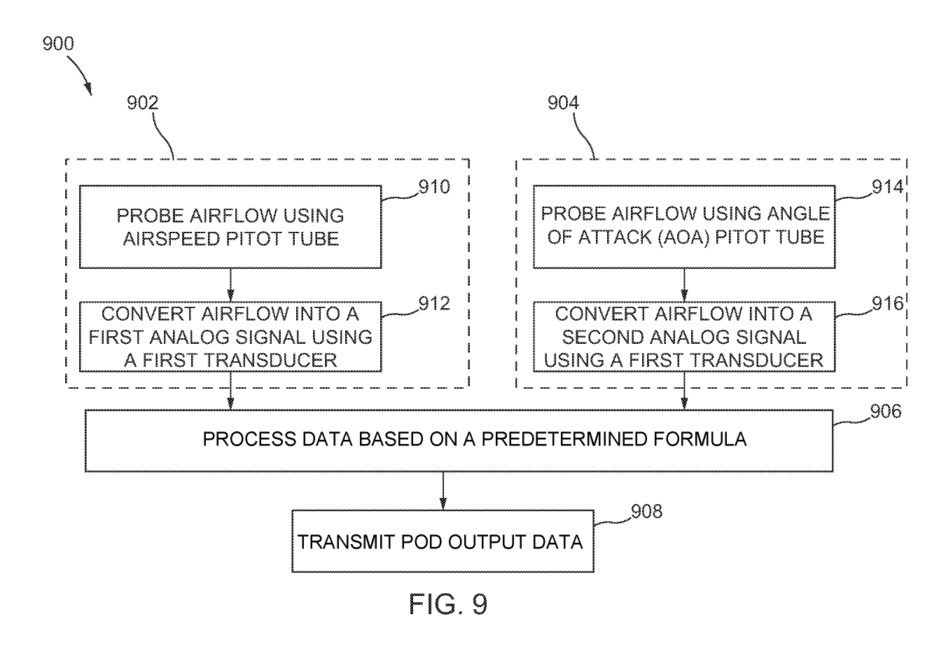

FIG. 9 conceptually illustrates a flow graph 900 corresponding to measuring air data using a portable sensor pod (e.g., 104, 330, 340, 600a, 600b, 600c) according to an embodiment. The method 900 includes a first operation path 902 in parallel with a second operation path 904. The first operation path 902 includes a probe operation 910 corresponding to probing air data using the airspeed pitot tube 352 and an operation 912 corresponding to converting the probe data into an analog signal S_{IAS}. At operation 910 the airspeed pitot tube probe 352 probes a differential pressure relating to indicated airspeed (IAS); and at operation 912 a transducer, such as a piezoresistive pressure transducer, converts the differential pressure into the analog signal S_{IAS}, which can then be provided to a microcontroller (e.g microcontroller 606).

The second operation path includes a probe operation 914 corresponding to probing air data using the angle of attack pitot tube 354 and an operation 916 corresponding to converting the probe data into an analog signal S_{AOA}. At operation 914 the angle of attack pitot tube probe 354 probes a differential pressure based on the installment angle (e.g. 30 degrees) relative to the airspeed pitot tube probe 352; and at operation 916 another transducer, such as a piezoresistive pressure transducer, converts the differential pressure into the analog signal S_{AOA}, which can then be provided to the microcontroller 606.

Next, at operation 906 the analog signals S_{IAS} and S_{AOA} can be processed using the microcontroller 606 based a predetermined formula. The predetermined formula can be programmed into the microcontroller 606 for the type of aircraft. Next, at operation 908 the pod output data can be transmitted via wireless carrier (e.g. Bluetooth) so that it can be received by an HMD system.

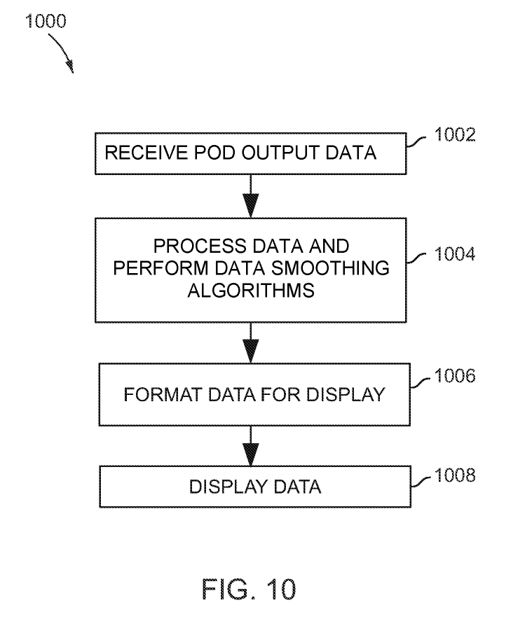

FIG. 10 conceptually illustrates a method 1000 of using a head mounted display system (e.g., 106, 500, 700a, 700b) according to an embodiment. The method 1000 comprises four operations 1002, 1004, 1006, and 1008 which can be operated in sequence. First, in operation 1002 the pod output data is received by the head mounted display system. With reference to FIG. 7A, operation 1002 can correspond to receiving the pod sensor data via the antenna 701 and RF module 706 within the hardware components 702. Then at operation 1004 the received pod output data can be processed by the hardware box. Operation 1004 can correspond to using the hardware components 702 for processing calculations and smoothing algorithms. For instance, angle of attack can be calculated by the hardware box at operation 1004. Next, operation 1006 can correspond to using the hardware components 702 to format the processed data for conveying as flight information on display 704; and finally operation 1008 can correspond to displaying the flight information on display 704.

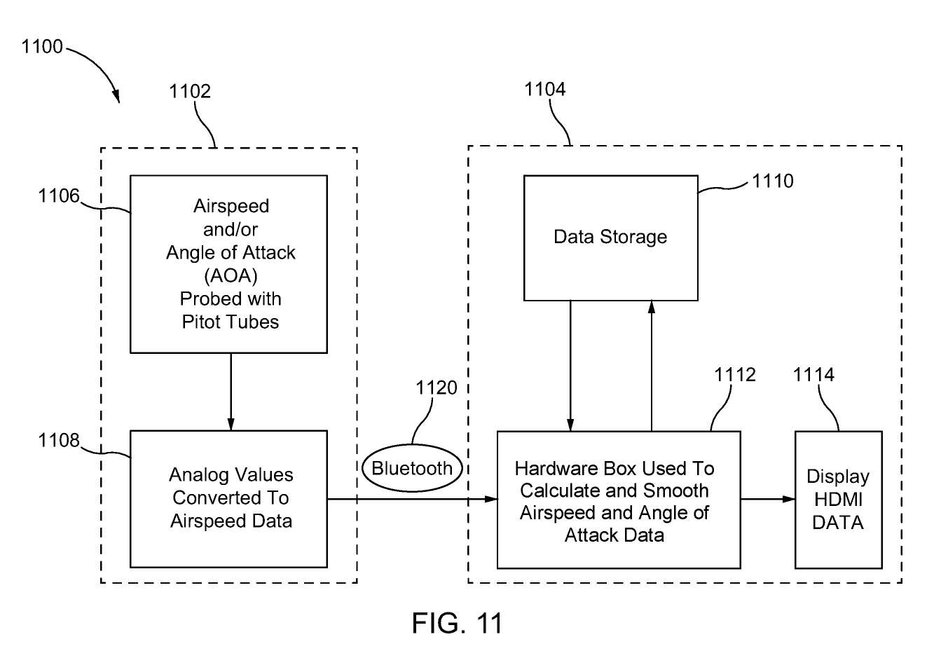

FIG. 11 illustrates a functional system block diagram 1100 of the portable avionics system (e.g., 102) for measuring air data according to an embodiment. Block 1102 can correspond to a high level block diagram of air data measurements within the portable sensor pod 104; and block 1104 can correspond to a high level block diagram of operations within the HMD system 106. Additionally, as shown in the system block diagram 1100, the portable sensor pod 104 and HMD system 106 are in wireless communication via Bluetooth 1120.

Block 1102 may include operations 1106 and 1008. Operation 1106 can correspond to measuring air data with the airspeed pitot tube 352 and the angle of attack pitot tube 354. In addition, operation 1106 can include the step of converting sensor data (differential pressure) into an analog signal (e.g. an analog voltage) using a piezoresistive pressure transducer. Block 1108 can also correspond to using a microcontroller 606 to convert the analog signals into digital data S₁, which can be communicated via Bluetooth 1120 as pod output data. The microcontroller can perform calculations and corrections to the analog signals by using a predetermined formula; and the digital data S₁ can comprise calibrated airspeed values, in digital format, based on the predetermined formula.

Block 1104 may include system blocks 1110, 1112, and 1114. System block 1112 can be a computer, tablet, a Raspberry Pi, and/or other wireless device which can wirelessly communicate via Bluetooth 1120. The system block 1112 can perform operations including processing calculations and smoothing algorithms. The system block 1110 can be removable data storage for storing flight information data processed by system block 1112. System block 1114 can be an HDMI display capable of displaying flight information in HDMI format.

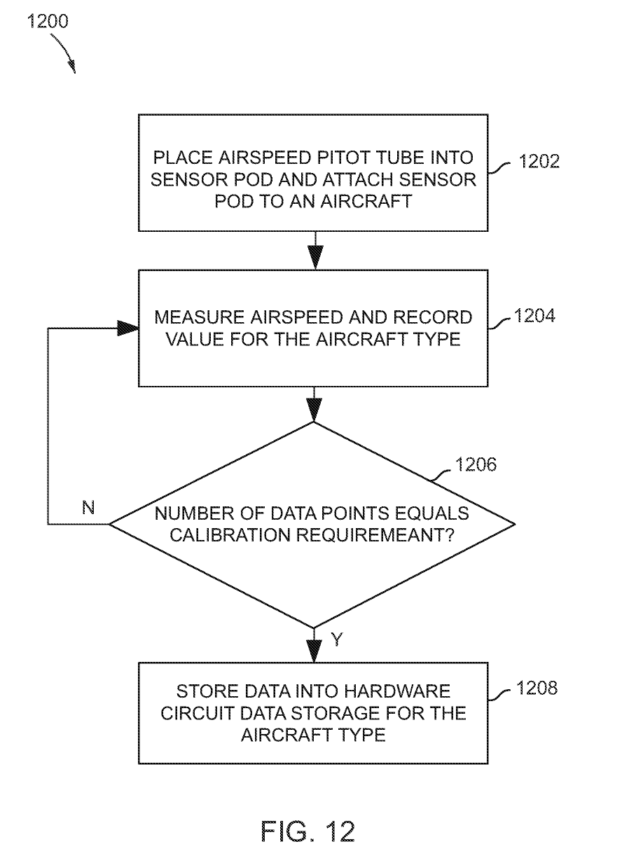

FIG. 12 illustrates a method 1200 for calibrating airspeed data for a type of general aviation aircraft according to an embodiment. The method 1200 includes steps 1202, 1204, 1206, and 1208 which can be performed in sequence to obtain calibration data. The calibration data can in turn be used to create and/or augment the predetermined formula for use within the microcontroller 606. At step 1202 an airspeed pitot tube 352 is placed into portable sensor pod 104 and the portable sensor pod 104 is attached to the aircraft. At step 1204 an airspeed calibration data point can be measured. The following step 1206 is a decision step which can determine if enough calibration points have been measured. If the calibration still requires additional data points, the decision loop can return to step 1204. If the calibration data points meet the calibration requirements, then the method 1200 continues to step 1208. In step 1208 data is stored and/or preprogrammed into the portable sensor pod for using with multiple types of aircraft. In other embodiments, a fixed number of calibration points (e.g. four data points) can be measured.

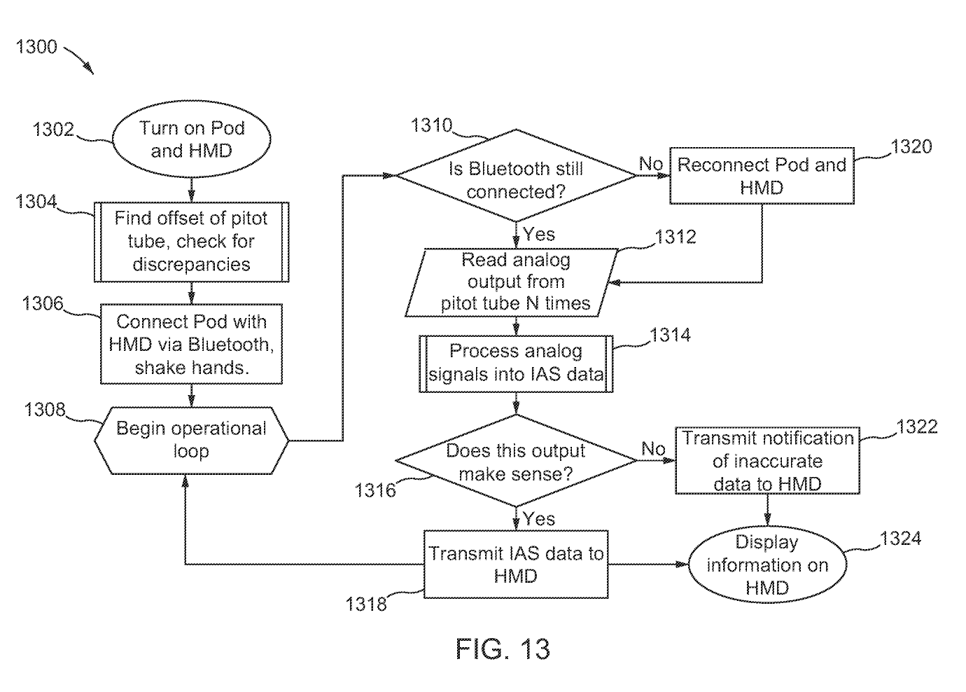

FIG. 13 illustrates a method 1300 for operating avionics hardware of the portable avionics system (e.g., 102) for measuring air data according to an embodiment. Method 1300 can apply to a portable avionics system using a head mounted display system and portable sensor pod. The method 1300 uses steps which can be performed to maintain a short duty cycle when polling portable sensor pod sensors, including the airspeed pitot tube 352 and the angle of attack pitot tube 354. Method 1300 can constantly check accuracy of the sensor outputs. A function of method 1300 can be to ensure that a pilot receives accurate information by checking the integrity of the portable sensor pod sensors before every flight and by checking the plausibility its sensors readouts based on previous outputs. For instance, before every flight the method 1300 can perform steps to check the integrity of the airspeed pitot tube 352 and the angle of attack pitot tube 354.

As shown in FIG. 13, method 1300 may include twelve logical steps 1302, 1304, 1306, 1308, 1310, 1312, 1314, 1316, 1318, 1320, 1322, and 1324. Steps 1302, 1304, and 1306 can comprise hardware and setup initialization procedures. For instance, step 1302 can apply to enabling electrical power to the head mounted display system 106 and to the portable sensor pod 104. At 1302, a pod and HMD may be turned on, where HMD can refer to an HMD system and/or hardware box of an HMD system. At 1304, an offset of a pitot tube may be found at the sensor pod, and the identified offset may be checked for discrepancies. At 1304, the sensor pod and HMD may establish communication with each other. For example, the pod may connect with the HMD via a handshake procedure, e.g., a Bluetooth handshake procedure.

Step 1308 can be a loop initialization point, where the main loop comprises steps 1308, 1310, 1312, 1314, 1316, and 1318. Step 1308 may begin once a connection is established between the pod and the HMD. Steps 1310 and 1316 are decision steps having local decision making loops. For instance, step 1310 can be used to determine if a wireless (e.g., Bluetooth) connection is broken and to execute step 1320 to reconnect the pod and HMB in response to determining that the connection is broken. If the connection is determined to be maintained at 1310, the analog output from the sensors, e.g., pitot tubes, may be read at 1312. For example, the analog output from the sensors may be read a predetermined number of times, e.g., N times. Then, at 1314, the analog signals may be processed, e.g., into IAS data. Step 1316 can be used to execute step 1322 if there are errors in the data. Thus, at 1316, a determination may be made as to whether the processed output makes sense, e.g., falls within an expected range or meets threshold. If an error is identified in the data at 1316, then, a notification of inaccurate data may be communicated from the pod to the HMD at 1322. The receipt of the error notification at the HMD may cause an error notification to be displayed to the user at the HMD. If no errors are detected at 1316, then the pod may transmit the processed data to the HMD. The HMD may then use the processed data to present a display of avionic information to the user at the display portion of the HMD.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

The above sub-processes represent non-exhaustive examples of specific techniques to accomplish objectives described in this disclosure, It will be appreciated by those skilled in the art upon perusal of this disclosure that other sub-processes or techniques may be implemented that are equally suitable and that do not depart from the principles of this disclosure.

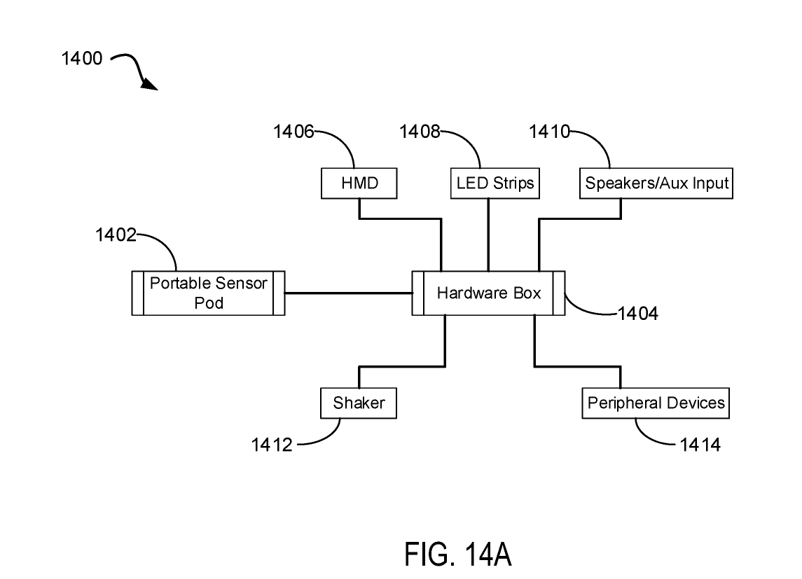

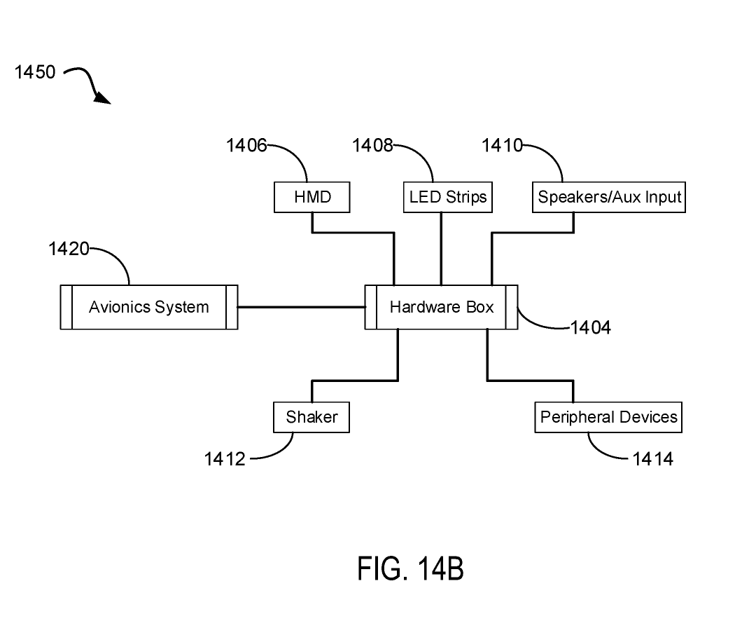

FIG. 14A illustrates a system block diagram of a portable avionics system 1400 using a hardware box 1404 according to aspects presented herein. Like the portable avionics system 102 described above, the portable avionics system 1400 includes a portable sensor pod 1402 and an HMD 1406 coupled to the hardware box 1404. Also, the portable sensor pod 1402, the HMD 1406, and the hardware box 1404 can be similar to the portable sensor pod 104 and corresponding HMD system 106 with hardware box 402. However, unlike the portable avionics system 102, the portable avionics system 1400 includes light emitting diode (LED) strips 1408, speakers with auxiliary inputs 1410, a shaker 1412, and peripheral devices 1414. The LED strips 1408, speakers with auxiliary strips 1410, shaker 1412, and peripheral devices 1414 can be part of a network of displays (warning devices) to augment the display features of the HMD 1406.

As shown in FIG. 14A, the portable sensor pod 1402 is electrically coupled to the hardware box 1404 via a wireless and/or wired interface. For instance, the hardware box 1404 can communicate with the portable sensor pod 1402 via Bluetooth as described above with respect to the portable avionics system 102. Also, the HMD 1406, the LED strips 1408, the speakers with auxiliary inputs 1410, the shaker 1412, and the peripheral devices 1414 can be electrically coupled to the hardware box 1404 via a wireless and/or wired interface. For instance, the HMD 1406 can communicate with the hardware box 1404 using Bluetooth and/or HDMI cables as discussed above; and the speakers with auxiliary inputs 1410 can connect via a universal serial bus (USB) cable and/or via a WiFi interface.

The LED strips 1408 can be used to light the interior of the cockpit in distinct colors to indicate the safety of the pilot. Similar to the display in the HMD system 106 and the HMD 1406, red can indicate an extremely dangerous situation while no illumination can indicate a healthy state. Other examples can be based on a variable degree of severity; LED colors can be used to indicate a variable degree of safety and/or peril the pilot may experience during flight.

The LED strips 1408 can be placed inside and/or outside the cockpit in a variety of ways and in a variety of general aviation aircraft. For instance, in a Cessna 152, which has a dashboard-like avionics panel, the LED strips 1408 can be lined or placed across the front top of the avionics panel. Alternatively, and additionally, the LED strips 1408 can be arranged to line the outsides of windows on the interior of the cockpit. The LED strips may be wirelessly coupled to the hardware box and in wireless communication with the components of the hardware box such that the components in the hardware box can wirelessly control the operation of the lights.

The speakers with auxiliary (AUX) inputs 1410 can be used inside the cockpit to verbally warn (“yell” at) the pilot when the pilot reaches an unsafe aircraft attitude. As one of ordinary skill in the art can appreciate, pilots can use headsets when they operate an aircraft; headsets can comprise AUX inputs and/or outputs for music and for recording. The AUX outputs provide audio output to a pilot. Additionally, conversations and transmissions made by the pilot can be recorded by the hardware box 1404 to provide “black box” functionality. The speakers with auxiliary (AUX) inputs 1410 can be wirelessly connected to the hardware box 1404 . In some embodiments they can be positioned behind the pilot's head. The power supply for the speakers, and similarly for the lights, can be self-contained and/or powered by the airplane's power supply.

The shaker 1412 can be a stick/yoke shaker, may be a haptic device that can be attached to the yoke/stick of the aircraft and wirelessly connected to hardware box 1404, to bring tactile functionality and to alert the pilot of a dangerous situation.

Alternatively, and additionally, the shaker 1412 can be implemented and used in a variety of ways and applications. For instance, the shaker 1412 can be positioned to shake the pilot's seat to alert the pilot of a dangerous situation. The shaker may be positionable in other locations, as well. For example, the shaker may be worn by the pilot.

Also, the shaker 1412 can be implemented using vibration functions of portable technology like phones, smart watches, smart device, or other wearable, many of which have small motors that serve to vibrate. The hardware box may form a wireless communication link with such devices and use the vibration or other motion function of the device to alert the pilot when the components of the hardware box detect a dangerous situation. For example, when used as part of a smart watch, the shaker 1412 can alert a pilot via the smart watch's internal motors.

In other embodiments, the peripheral devices 1414 can include devices such as smart phones and/or watches with additional display functionality.

Although the portable avionics system 1400 shows the hardware box 1404 as being connected to a network of displays including an HMD 1406, LED strips 1408, speakers with AUX inputs 1410, a shaker 1412, and peripheral devices 1414, other configurations having greater or fewer displays are possible. For instance, in some embodiments the portable avionics system 1400 can include just the HMD 1406 and the LED strips 1408.

As one of ordinary skill in the art can appreciate, traditional avionics systems may include a central avionics panel. Advantageously, the hardware box 1404 can function as a central computer performing the processing for a network of displays. The network displays, including the HMD 1406, LED strips 1408, speakers with AUX inputs 1410, shaker 1412, and/or peripheral devices 1414 can be positioned on and/or away from the central avionics panel so as to provide additional alerts to the pilot.

FIG. 14B illustrates a system block diagram of a general avionics system 1450 using a hardware box 1404 according to aspects presented herein. The general avionics system 1450 is similar to the portable avionics system 1400 except the portable sensor pod is replaced with a general avionics system 1420. The avionics system 1420 can be a preinstalled and/or preexisting avionics system within the aircraft. The avionics system 1420 can be coupled to hardware box 1404 via Bluetooth and/or wired interface.

The previous description is provided to enable any person skilled in the art to practice the various aspects described herein. Various modifications to these exemplary embodiments presented throughout this disclosure will be readily apparent to those skilled in the art, and the concepts disclosed herein may be applied to using other types of avionic sensors and/or head mounted displays. Additionally, the concepts may be applied to other forms of aircraft and transport vehicles.

Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A portable avionics system for displaying aircraft specific flight information for a plurality of general aviation aircraft types, the portable avionics system comprising:
a portable sensor pod comprising at least one sensor, the portable sensor pod configured to convert sensor data from the at least one sensor into pod output data; and
a head mounted display (HMD) system comprising:
a hardware box configured to receive the pod output data and to convert the pod output data into the aircraft specific flight information; and
a wearable display configured to display the aircraft specific flight information.

2. The portable avionics system of claim 1,
wherein the portable sensor pod is configured to convert the sensor data from the at least one sensor into the pod output data based upon a predetermined formula, the predetermined formula calibrated for the plurality of general aviation aircraft types.

3. The portable avionics system of claim 1, wherein the portable sensor pod further comprises a sensor pod circuit, the sensor pod circuit comprising:
a transducer configured to receive the sensor data from the at last one sensor and to provide a transducer output signal proportional to the sensor data; and
a wireless transmitter configured to transmit the pod output data, the pod output data comprising a digital representation of the transducer output signal.

4. The portable avionics system of claim 3, wherein the sensor pod circuit further comprises:
a microcontroller configured to convert the transducer output signal into the digital representation of the transducer output signal based upon a predetermined formula, the predetermined formula calibrated for the plurality of general aviation aircraft types.

5. The portable avionics system of claim 1, wherein the portable sensor pod further comprises:
a flange section configured for permanent mounting to the underside of a wing of the aircraft; and
an aerodynamically streamlined attachable container section, wherein the attachable container section comprises a nose cone section and a body section, and wherein the attachable container section is attached to the flange section with a removable pin.

6. The portable avionics system of claim 5, wherein the flange section, the nose cone section, and the body section are additively manufactured.

7. The portable avionics system of claim 5, wherein the flange section is mounted to the underside of the wing of the general aviation aircraft using an adhesive, and wherein the body section and the nose cone section are sealed together to form the attachable container section.

8. The portable avionics system of claim 1,
wherein the hardware box comprises:
a wireless receiver configured to receive the pod output data; and
a processor configured to convert the pod output data into the aircraft specific flight information; and
wherein the wearable display is a wearable display lens.

9. The portable avionics system of claim 1, wherein the at least one sensor comprises a first pitot tube, and the aircraft specific flight information comprises airspeed.

10. The portable avionics system of claim 9, wherein the at least one sensor comprises a second pitot tube, and the aircraft specific flight information comprises angle of attack.

11. A method of displaying flight information with a system configured for a plurality of general aviation aircraft types, the method comprising:
attaching a portable sensor pod to a select one of the plurality general aviation aircraft types;
measuring sensor data using the portable sensor pod;
converting the sensor data to pod output data using the portable sensor pod;
wirelessly receiving the pod output data at a head mounted display (HMD) system;
converting the pod output data into aircraft specific flight information using a hardware box; and
displaying the aircraft specific flight information on a wearable display.

12. The method of claim 11, wherein converting the sensor data to the pod output data using the portable sensor pod comprises:
using a microcontroller to convert the sensor data to the pod output data based on a predetermined formula.

13. The method of claim 12, wherein the predetermined formula is calibrated for the plurality of general aviation aircraft types.

14. The method of claim 11, wherein attaching the portable sensor pod to the select one of the plurality of general aviation aircraft types further comprises:
permanently mounting a flange section of the portable sensor pod under a wing of the select one of the plurality of general aviation aircraft types;
sealing a sensor pod circuit and at least one sensor in an aerodynamically streamlined attachable container section, wherein the attachable container section comprises a nose cone section and a body section; and
attaching the attachable container section to the flange section with a removable pin.

15. The method of claim 14, wherein the flange section, the nose cone section, and the body section are additively manufactured.

16. The method of claim 14, wherein permanently mounting the flange section of the portable sensor pod under a wing of the select one of the general aviation aircraft types comprises:
mounting the flange section of the portable sensor pod using an adhesive.

17. The method of claim 11, wherein converting the sensor data to the pod output data using the portable sensor pod comprises:
receiving the sensor data from the at last one sensor;
providing a transducer output signal proportional to the sensor data;
converting the transducer output signal based on a predetermined formula; and
wirelessly transmitting the pod output data, the pod output data comprising a digital representation of the transducer output signal.

18. The method of claim 11, wherein converting the pod output data into aircraft specific flight information using a hardware box comprises:
wirelessly receiving the pod output data; and
converting the pod output data into the aircraft specific flight information.

19. The method of claim 11, wherein the at least one sensor comprises a first pitot tube and a second pitot tube, and the aircraft specific flight information comprises airspeed and angle of attack.

20. An avionics system for conveying aircraft specific flight information for a plurality of general aviation aircraft types, the avionics system comprising:
an avionics sensor hub comprising at least one sensor, the avionics sensor hub configured to provide hub output data; and
an avionics warning system comprising:
a hardware box configured to receive the hub output data and to convert the hub output data into the aircraft specific flight information; and
a plurality of warning devices configured to convey the aircraft specific flight information.

21. The avionics system of claim 20, wherein the avionics sensor hub is a portable sensor pod configured to convert sensor data from the at least one sensor into the hub output data.

22. The avionics system of claim 20, wherein the plurality of warning devices comprises a wearable display configured to display the aircraft specific flight information.

23. The avionics system of claim 20, wherein the plurality of warning devices comprises a light emitting diode (LED) strip configured to display light in response to the aircraft specific flight information.

24. The avionics system of claim 20, wherein the plurality of warning devices comprises a stick shaker configured to shake in response to the aircraft specific flight information.

25. The avionics system of claim 20, wherein the plurality of warning devices comprises an audible device configured to provide sound in response to the aircraft specific flight information.

26. The avionics system of claim 20, wherein the hardware box comprises:
a wireless receiver configured to receive the hub output data; and
a processor configured to convert the hub output data into the aircraft specific flight information.
